(19) United States
(12) Patent Application Publication
(10) Pub. No.: US 2011/0017886 A1
(43) Pub. Date: Jan. 27, 2011

(54) Ashford amp guitar stand

(76) Inventor: Dale Frederick Ashford, Rockford, IL (US)

Correspondence Address: REINHART BOERNER VAN DEUREN P.C., 2215 PERRYGREEN WAY, ROCKFORD, IL, 61107, US

(21) Appl. No.: 12/462,655

(22) Filed: Aug. 7, 2009

Related U.S. Application Data
(60) Provisional application No. 61/188,263, filed on Aug. 8, 2008.

(51) Int. Cl. F16M 13/02

(52) U.S. Cl. 248/205.1

(57) ABSTRACT

One embodiment of a support for a musical instrument, specifically a guitar. The Ashford Amp Guitar Stand is a device designed to hold a guitar while it is not being played and to attach to a wooden-side of an amplifier so that it is kept secure when not in use. The guitar and amplification device can be simultaneously moved around the stage as one unit. The device is made of molded plastic with foam covering on the arm and neck of the device to cushion the guitar. When not in use, pivoting supports, which enable the guitar to be stood upright against the attached plastic frame, are structured to be folded flat against the frame.

### CROSS REFERENCE TO RELATED APPLICATIONS

This application claims the benefit of provisional patent application Ser. No. 61/188,263 filed 2008 Aug. 8 by the present inventor.

### FEDERALLY SPONSORED RESEARCH

Not applicable

### SEQUENCE LISTING OR PROGRAM

Not applicable

### BACKGROUND

1. Field of Invention

This invention relates to support for a musical instrument, specifically an electric guitar, when the guitar is not in use during live performances. The stand is designed to attach to an amplification device.

2. Prior Art

Patent documents considered relevant to the present invention (search conducted by Litman Law).

| | |
|---|---|
| Patent Document No. | Inventor |
| Des. 270,120 | McPherson, Sr. |
| US 2008/0028913 Al | Driscoll |
| 3,765,633 | Caudill |
| 3,958,786 | Mann |
| 4,345,732 | Gallegos |
| 4,546,688 | Cuccio |
| 4,991,809 | Harkey |
| 5,313,866 | Smith |
| 5,346,073 | Broersma et al. |
| 5,350,143 | Hoshino |
| Foreign Patent Document No. | Country & Date |
| 609843 (attached) | France, August 1926 |

Internet Documents
Wallacher Amplifier Mount guitar stand, http//www.music123.com/Wallacher-Amplifier-Mount-Guitar Stand-451514-i1142188.Music123, 2 pages printed from the Internet (attached)
   Many musicians who play guitars and perform live require a way of supporting their guitars when they are not playing it. They often place their guitars against their amplification device where it often falls or is knocked—possibly harming the instrument. Some musicians carry a stand for their guitar to be used during live performances when they are not playing the guitar. However, the standard guitar stand is unstable, awkward to set up and transport. Often, there is not enough room on the stage to set up guitar stands.

This invention is designed to address two uses for the guitar player—1) a way of keeping the guitar locked in place and secure while not being played in a way that is space saving; and 2) a way to roll the guitar and amplification device as one piece (if the musicians desires to do so).

U.S. Pat. No. 3,765,633 to Caudill (1973) allows the guitar and amplification to be rolled simultaneously. However, when the guitar is attached to the amplifier, the bottom of the guitar is on the floor or ground and the finish on the guitar could possibly be harmed. Additionally, the guitar cannot be locked up to prevent someone from taking it off the stand and playing with it.

U.S. Pat. No. 4,345,732 to Gallegos (1982) while allowing for the slight uplifting of the guitar off the floor, has no way to lift differently shaped guitars and no way to lock the instrument to the amplification device.

U.S. Patent DES 270,120 to McPherson, Sr. (1983) attached the guitar to the stand in a way that it could only be used to hold the guitar while not being played. It could not be used to carry the guitar and amplification device simultaneously.

U.S. Patent 2008/0028913A-1 to Driscoll (2008) provides support for the guitar on the amplification device but it is not a permanent support as it is either slid under the supporting handle of the amplification device or slid between two stacked amplification devises by a finger hole at one end. The musician must carry the part as a separate piece of equipment and it could be easily lost. Further, if the stand is slid between two amplification devises, all three pieces could be knocked over and the guitar harmed. Additionally, this device leaves the guitar unlocked and sitting on the floor.

General types of stands have been proposed—for example U.S. Pat. No. 4,546,688 to Cuccio (1985), U.S. Pat. No. 4,991,809 to Harkey (1991), and U.S. Pat. No. 5,313,866 to Smith (1994). All of these devices are detachable devices that are not secure and suffer from a number of disadvantages:
a) They provide no way for the musician to lock their valuable equipment on to the amplification unit.
b) They are detachable devices and not as sturdy as the current invention.
c) The instruments have to sit on the floor or ground when placed in the device.

### SUMMARY

In accordance with one embodiment the Ashford Amp Guitar Stand comprises a foam-cushioned molded plastic permanent guitar stand that when affixed to the wood side of an amplification device allows the musician to place and lock the guitar in the guitar stand and also allows the musician to move the amplification device and guitar simultaneously on stage.

### BRIEF DESCRIPTION OF THE DRAWINGS

One embodiment of the invention will now be described in conjunction with the accompanying drawings in which:

FIG. 1 is a topical view of the guitar stand on the side of an amplifier with the stand attached to the side of the amplifier. The stand is a guitar instrument support constructed in accordance with the invention. The stand unit will attach to either wood side of the amplifier. The stand is mounted with wood screws to hold the stand in place. This depiction shows the unit when it is open and ready to hold a guitar. The stand is composed hard tubular plastic.

FIG. 2 is an angular view of the stand. This view shows the stand in the open position where the base of the guitar fits into the two lower swinging supports. On the top of the stand is where the neck of the guitar fits and is held into place by a swinging vertical arm that is able to be locked with a lock being run through the eye screws.

FIG. 3 is an angular view of the stand. This view depicts how two I-bolts are attached to the upper neck support brace to allow for the placement of a security lock to keep the guitar in place and discourage tampering with the guitar. The dotted line shows the arm that holds the guitar neck up to release the guitar.

FIG. 4 is an angular view of the stand. This view shows how the support arms at the base and the top of the stand will fold flat against the amplifier unit this will allow for a cover to be placed over the amplifier for transportation and compactness of the amplifier with the stand attached.

FIG. 5 is an angular view of the stand with the component pieces attached (FIG. 6-9). In this depiction, FIG. 6 are the sides, FIG. 7 are the arms that hold the guitar body, FIG. 8 are the arms that hold the guitar neck, and FIG. 9 are the spacers.

FIG. 6 is a side view of the body of the invention that shows the dimensions.

FIG. 7 shows the guitar body support arms. (See FIG. 5 for how it is attached)

FIG. 8 shows the guitar neck support arms. (See FIG. 5 for how it is attached)

FIG. 9 shows the spacer. (See FIG. 5 for how it is attached)

### DETAILED DESCRIPTION

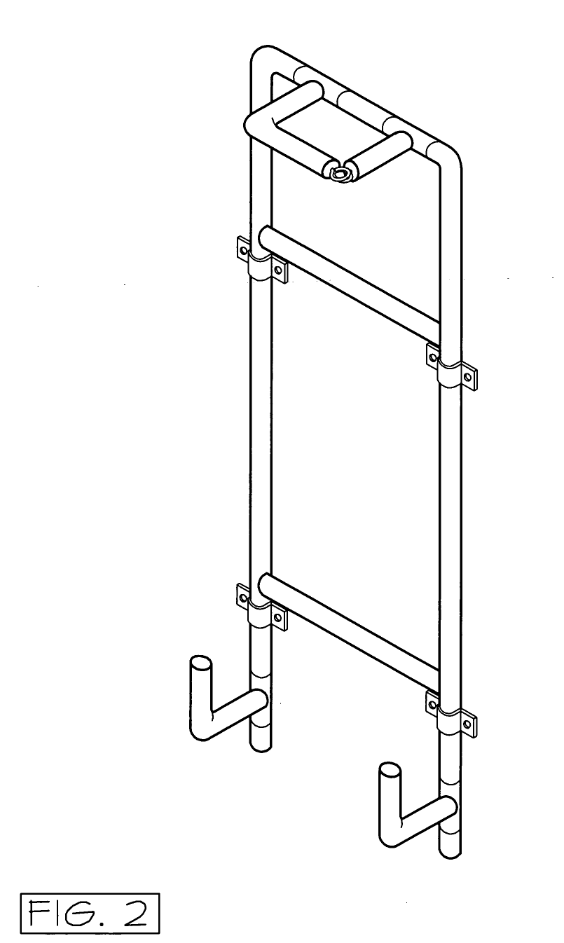

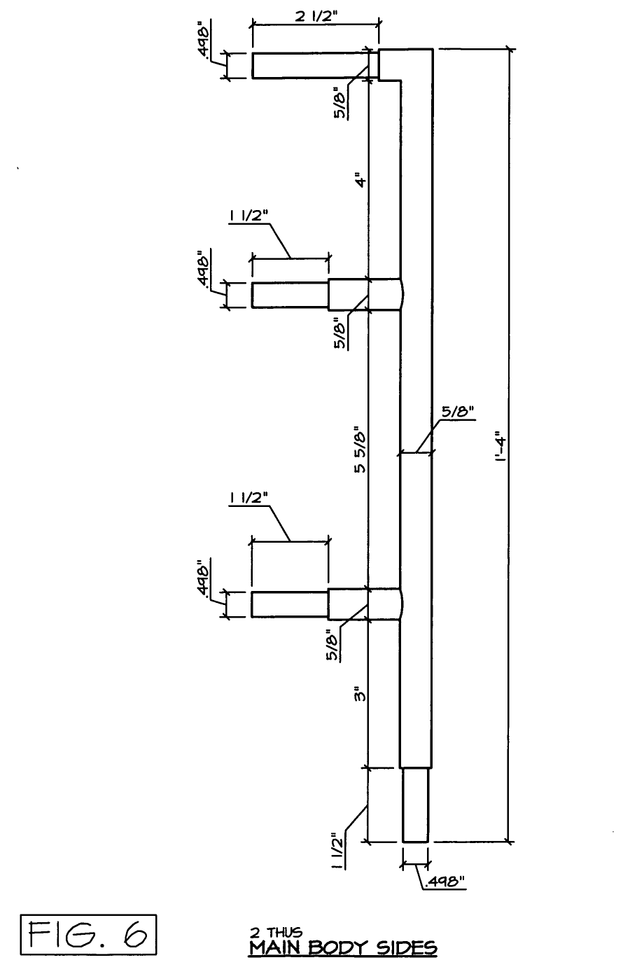

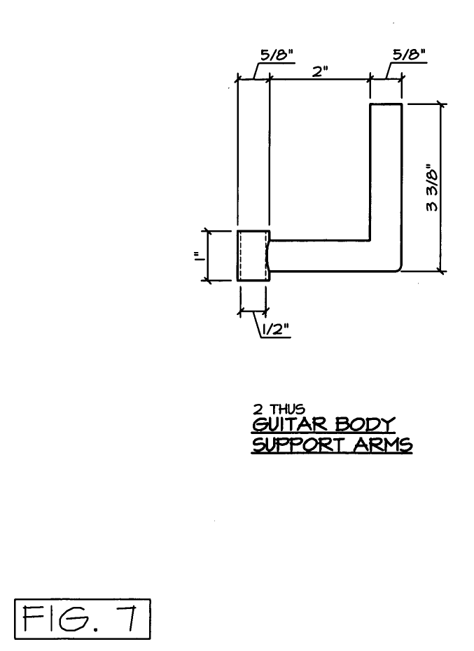

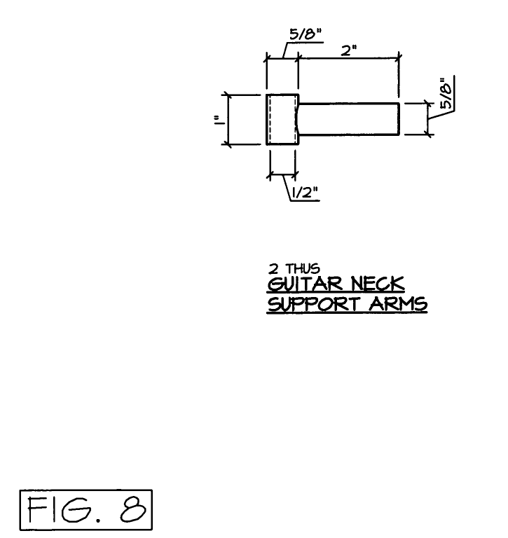

The embodiment of the stand is illustrated in FIG. 2. The stand is approximately 18 inches long and 7⅜ inches wide. It is made of molded plastic, which is approximately ⅝ inches round. The body has eight moving parts. The body (FIG. 6) has four moving parts that swivel on the top and legs that allow the support arms for the lower part of the guitar and the support arms for the neck to fold down. The lower arms (FIG. 7) are 3.5 inches in length and the neck (FIG. 8) is 3.875 inches in length and fold down for storage.

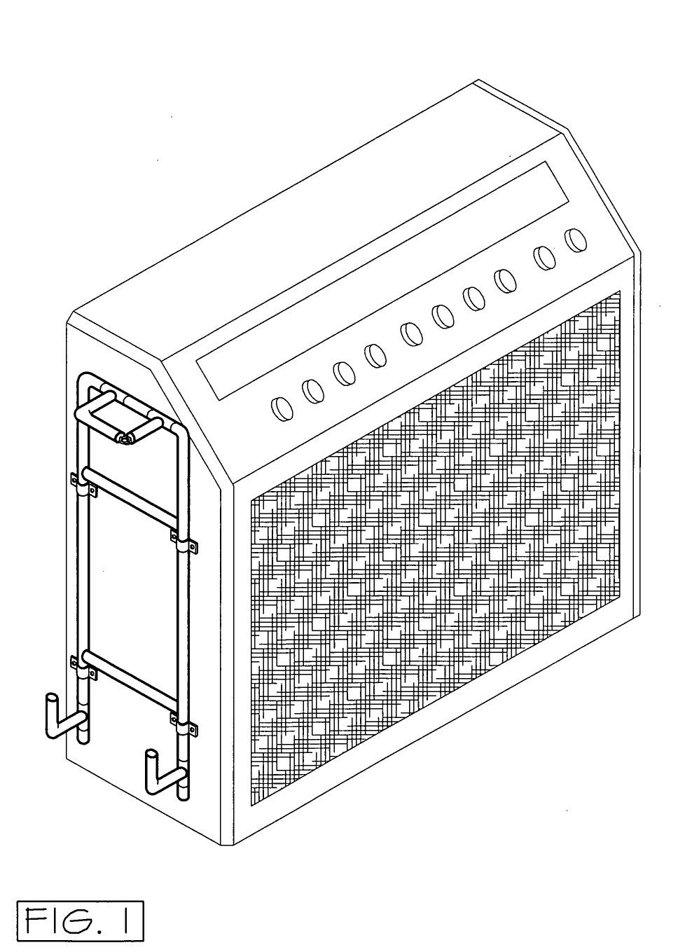

With respect to FIG. 1 of the drawings, the stand is shown attached to the amplifier unit on the wooden side. There are eight holes drilled into the amplifier to attached the stand (FIG. 2). The holes are drilled with a 7/64″ drill bit into the wood side of the amplification device and then 8×1 inch wood screws are used to attach the frame (FIG. 2) to the amplifier.

With respect to FIG. 2 of the drawings. This FIGURE depicts the unit and all components assembled together unattached to the amplification unit. The four clamps for the wood screws are clearly discernable in FIG. 2.

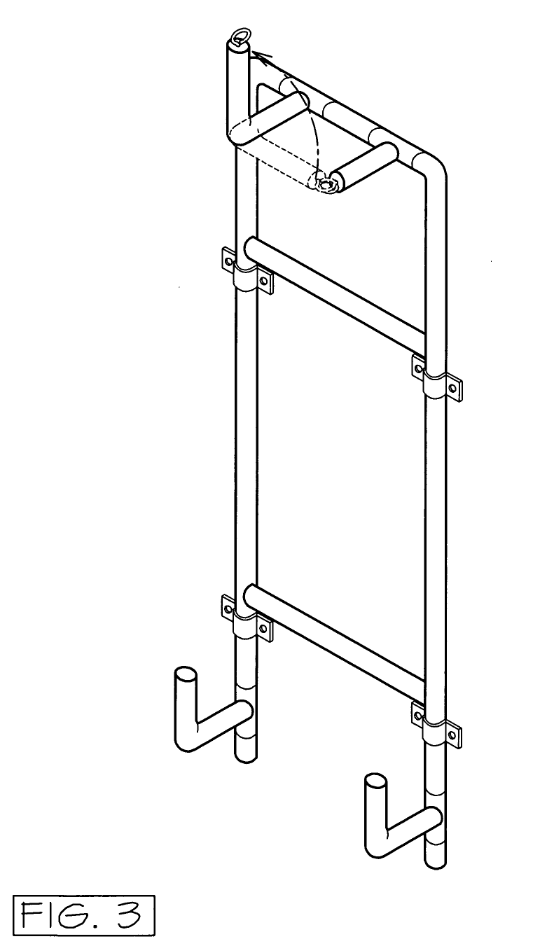

With respect to FIG. 3 of the drawings. This figure shows how the component that holds the neck (FIG. 8) of the guitar operates (see dotted lines). The neck is molded to the body (FIG. 2) on a piece that swivels to allow the neck to fold down. The neck folds up to allow the guitar to be removed.

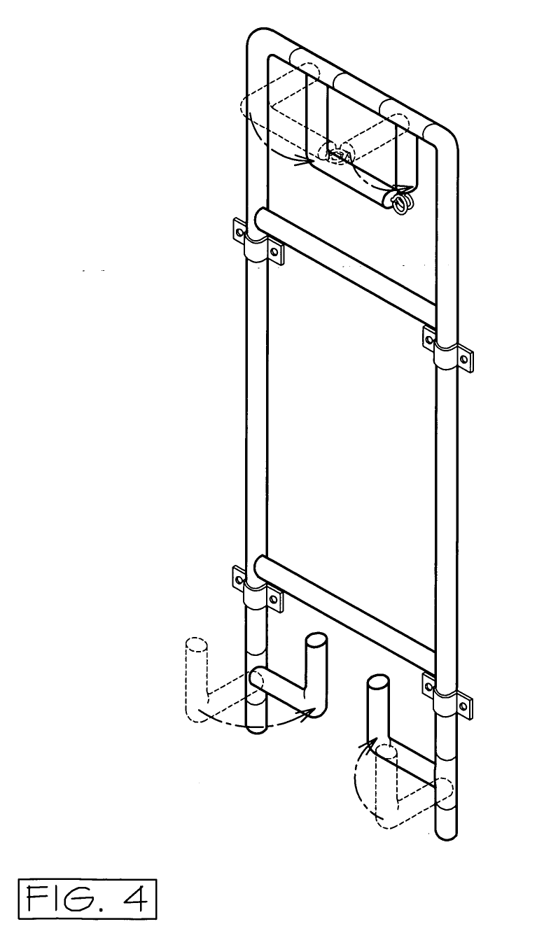

With respect to FIG. 4, this shows the folding of the stand for transport when on the amp (FIGS. 7 and 8).

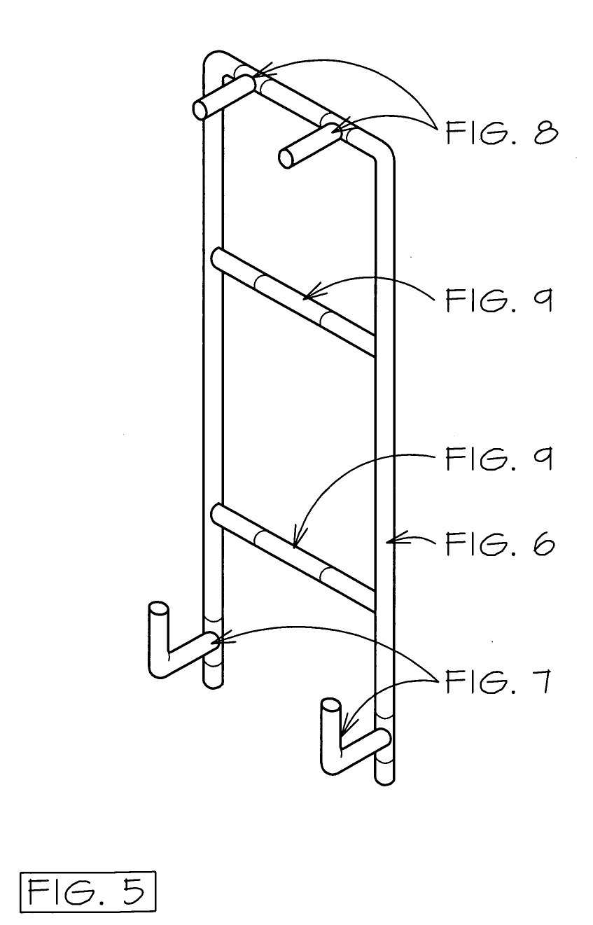

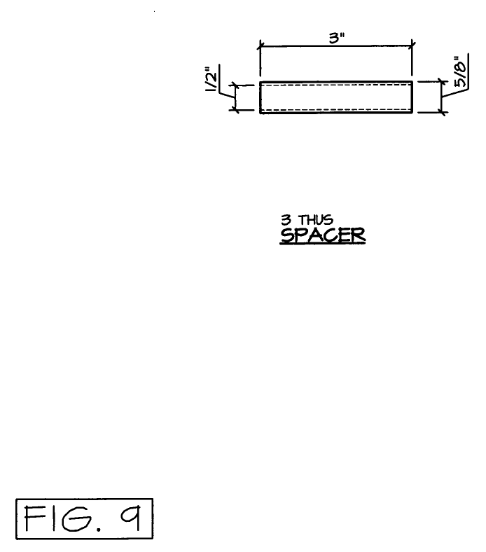

With respect to FIG. 5, this shows the component pieces and how the spacers are used (FIG. 9).

With respect to FIG. 6, this shows the main body sides and the dimensions.

With respect to FIG. 7, this shows the two support arms for the body of the guitar. These arms hold the guitar to keep it from sitting on the floor.

With respect to FIG. 8, this shows the support arms for the neck of the guitar to hold the guitar in place to keep it from falling.

With respect to FIG. 9, this shows the spacer this fits into the main body of the amplification stand unit.

### DRAWINGS

### Reference Letters

7—Guitar Body Support Arms
8—Guitar Neck Support Arm
9—Spacer
6—Main Body Sides

### OPERATION

Utilization of the Ashford Stand allows the musician to use the guitar during playing engagement or at home without having to unpack their instrument. The unit is mounted on a base which will provide a secure and stable environment for the guitar, which will reduce guitars being knocked down from being leaned against walls or amplifiers. The Stand makes the guitar more accessible to the musician as they will not have to re-case the guitar between music sets or when at home. A major improvement of this invention is that it keeps the guitar off of the floor. Constantly leaving guitars on the various floor surfaces has the potential to damage the ascetics of the guitar and reduce it value. Additionally, most other units of this type are stand along by attaching the stand to the amplifier it reduces a common complaint that musicians have of leaving their stands at various musical engagements.

I claim:

1. A stand for a guitar, said guitar including a guitar neck and a guitar base, whereby said guitar is placed in a stand that is permanently attached to the wood side of an amplification device, comprising
A stand as set forth in claim 1, where the extended arms and neck are foldable into the unit when not in use.
A stand as set forth in claim 1 where the neck of the guitar provides a space for lock so the guitar can be locked into place and kept secure during live performances.
A stand as set forth in claim 1, which allows the guitar and amplification device to be rolled as one unit.
A stand as set forth in claim 1 where the guitar is kept cushioned to prevent damage to its finish.
